(19) United States
(12) Patent Application Publication
(10) Pub. No.: US 2007/0182515 A1
(43) Pub. Date: Aug. 9, 2007

(54) Linear drive device with a magnet yoke body and a permanent magnetic armature

(75) Inventor: Gunter Ries, Erlangen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/591,086

(22) PCT Filed: Mar. 7, 2005
(86) PCT No.: PCT/EP05/51006

§ 371 Date: Aug. 29, 2006

(51) Int. Cl. H01F 7/08

(52) U.S. Cl. 335/262

(57) ABSTRACT

A drive device comprising at least one exciter winding, which is used to produce a modifiable magnetic field, consisting of an associated magnetic-flow guiding main yoke body and a counter yoke body, in addition to an armature body, which can be set into an axially oscillating motion, with two permanent magnetic magnet parts which are disposed between the yoke bodies. The limbs of the yoke bodies have reciprocal distances and predetermined axial widths which are adapted to the axial extension of the magnet parts.

The invention relates to a linear drive device
comprising at least one excitation winding for producing a variable magnetic field,
comprising a magnetic-flux-guiding main yoke body which accommodates the excitation winding and is provided with limbs,
comprising a winding-free counter-yoke body which is located opposite to the main yoke body, wherein an axial gap is provided between the main yoke body and the counter-yoke body,

and
comprising at least one armature body provided with at least two permanent magnetic magnet parts arranged axially one behind the other and having opposite magnetisation, wherein the armature body is to be set in axially oscillating motion by the magnetic field of the excitation winding in the gap.

Such a drive device is deduced from U.S. Pat. No. 5,559,378 A.

Corresponding drive devices are used in particular to set pump pistons of compressors in linear oscillating motion. The system comprising such a compressor and an associated linear drive device is therefore also designated as a linear compressor (see, for example, JP 2002-031054 A). In corresponding known linear compressors, its oscillatory parts are designed for a specific oscillation frequency.

The drive device known from U.S. Pat. No. 5,559,378 A comprises at least one excitation winding in an E-shaped laminated iron yoke as a three-pole main yoke body. Opposite to this is a counter-yoke body containing no excitation winding parts and serving as the part which reduces the magnetic resistance in a magnetic flux circuit. A slit-shaped gap is formed between the main yoke body and the counter-yoke body in which the magnetic field exerts a force, which depends on the direction of the current, on two alternately polarised plate-shaped permanent magnets of an axially movable armature body located therein. This movement can be used to drive a pump piston of a compressor.

In the drive device known from the US-A specification, the pole surfaces of the two lateral limbs of the E-shaped main yoke body should each have a significantly greater axial extension than the middle limb. This is ensured by constructing the lateral limb as kinked on its side facing the armature body to form a part extending parallel to the surface of the armature body. A corresponding main yoke body is accordingly expensive to produce. In addition, it is difficult to arrange the excitation winding parts in the winding windows formed between the limbs.

It is thus the object of the present invention to construct the linear drive device having the features specified initially such that its structure is simplified.

A first solution of this object is achieved according to the invention with the features according to claim 1. Accordingly, all limbs of the main yoke body should have the same axial widths at their pole surfaces facing the armature body, wherein neighbouring limbs are each spaced apart from one another axially by the pole surface spacing and the axial extension of each magnet part should be at least approximately equal to the sum of the pole surface width and a pole surface spacing. Deviations of the sum by +10% should be included.

The advantages associated with this embodiment of the drive device can be seen in particular in a simple and cost-effective structure of the excitation winding whilst the weight of the magnetic-flux-guiding material is restricted.

Advantageous embodiments of the linear drive device according to the invention are obtained from the dependent claims. In this case, the following features can additionally be provided individually or in combination for the drive device according to claim 1:
The main yoke body can comprise pole shoe bodies in the area of its pole surface, whose axial extension is greater than the corresponding extension of the winding windows which holds the excitation winding between the limbs. At the same time, the pole shoe bodies can be placed on the respective limbs. A larger winding space and therefore a larger wire cross section in the winding windows can thus be achieved with this measure. A lower coil resistance and consequently lower electric losses are associated therewith.

A further solution of said problem can be seen according to the invention in the measures according to claim 4. Accordingly, the linear drive device having the features specified initially should be embodied in such a manner that the main yoke body and the counter-yoke body form a common yoke body with common lateral limbs, wherein the main yoke body has a central limb which has an axial width at its pole surface facing the armature body, which is at least as large as the axial extension of each magnet part.

This further embodiment is characterised by a restricted magnet width and accordingly little permanent magnet material. Consequently, in addition to the advantage of material costs, the moving mass is correspondingly lower.

This embodiment of a drive device can advantageously additionally have the following features individually or in combination:

Thus, the axial width of the central limb can be greater than that of the lateral limbs, wherein the axial width of the lateral limbs is in each case half as large as that of the central limb. This is therefore associated with a corresponding restriction of the magnetic-flux- guiding material of the common yoke body.
In addition, it is particularly advantageous if the stroke of the armature part during the oscillating movement is smaller than the corresponding extension of each winding window which holds at least one excitation winding between the limbs. In particular, the axial extension of each winding window can be equal to the maximum distance of the pole surfaces of the central limb from the corresponding lateral limbs. This enables the excitation winding to be assembled easily. In addition, hitting of the armature body against the lateral limbs during its oscillating movement is avoided.

Advantageous embodiments of the two embodiments of linear drive devices according to the invention can additionally have the following features individually or in combination:
Thus the counter-yoke body can comprise limbs having an axial width at the pole surfaces corresponding to the limbs of the main yoke body. Instead, the counter-yoke body can be embodied as plate-shaped or rectangular, i.e. it has no defined limbs.
Particularly advantageously, the axial width of the at least one pole surface is at least approximately equal to the stroke of the armature body during its oscillating movement.
the magnet parts are appropriately embodied as plate- or strip-shaped.
The armature body of the drive device is preferably rigidly connected to a pump piston of a compressor.

Further advantageous embodiments of the linear drive device according to the invention are obtained from the dependent claims not discussed previously and the drawings.

The invention is explained in further detail hereinafter using preferred exemplary embodiments with reference to the drawings. In the figures:

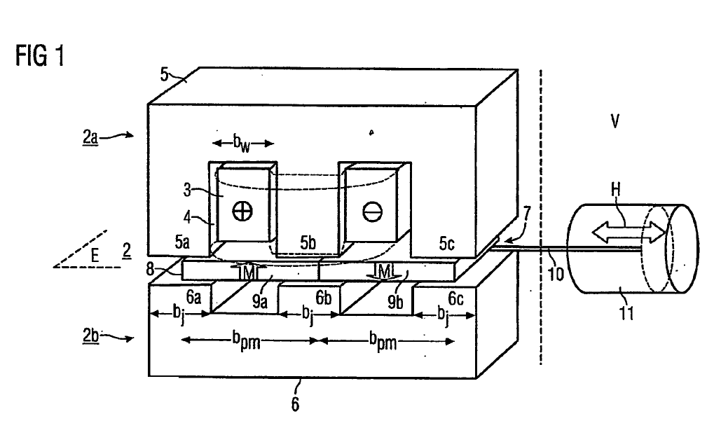

FIG. 1 is a schematic oblique view of a linear drive device according to the invention,

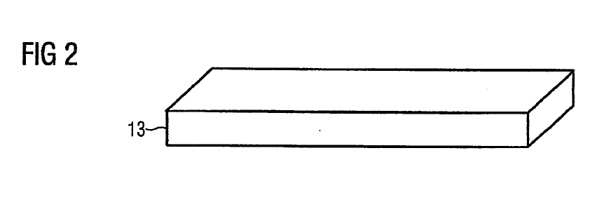

FIG. 2 is a particular embodiment of a counter-yoke body,

FIG. 3 is a particular embodiment of a main yoke body

and

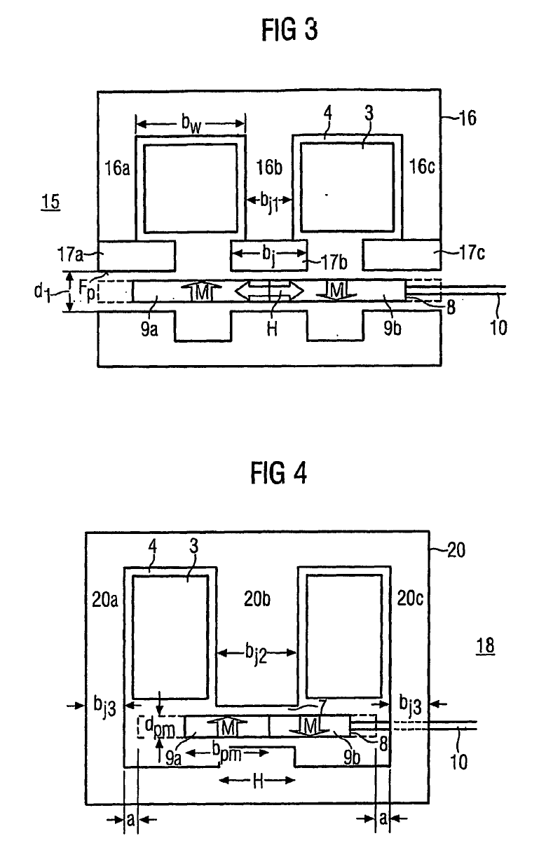

FIG. 4 is a particular embodiment of a main and counter-yoke body.

In the figures corresponding parts are each provided with the same reference numerals.

In the linear drive device according to the invention indicated in FIG. 1, embodiments known per se are assumed such as those provided for linear compressors (see U.S. Pat. No. 5,559,378 A specified initially). Substantially only an upper and a lower part 2a or 2b of such a drive device can be seen from the oblique view in the figure, these parts being arranged on both sides of an axial plane E. In its upper part 2a, the drive device 2 comprises an excitation winding 3 in winding windows 4 between limbs 5a to 5c of a magnetic-flux-guiding main yoke body 5. This yoke body 5 has the known E-shape, for example. A magnetic-flux-guiding counter-yoke body 6, also E-shaped, is provided in the lower part 2b on the opposite side of the plane E. This counter-yoke body carries no excitation winding parts so that its limbs 6a to 6c can be embodied as substantially shorter compared with the limbs 5a to 5c perpendicular to the plane E. Located in a central, channel-like or slit-like gap 7 between these two opposing yoke bodies or their opposing pole surfaces Fₚ is a magnetic armature or armature body 8 comprising, for example, two plate- or strip-shaped permanent magnets 9a and 9b of a permanent magnetic material such as NdFeB, for example. Their magnetisations M directed anti-parallel perpendicular to the plane E are indicated by arrowed lines. This armature body 8 can execute an oscillating movement in the axial direction in the plane E in the variable magnetic field of the excitation winding 3. This armature body comprises at least one axially lateral extension part 10 which is merely indicated and which is advantageously rigidly connected to a pump piston 11 of a compressor V not shown in detail in the figure. This pump piston consequently executes the axially oscillating movement of the armature part 8 about an armature stroke H.

According to the invention, all the limbs 5a to 5c and 6a to 6c have the same axial widths bⱼ in the area of their pole surfaces Fₚ. The width bⱼ can be selected so that it corresponds to the stroke H of the moving armature body. In addition, the axial width bⱼ and the pole surface spacing of neighbouring pole surfaces, which corresponds to the winding window width b_{w}, is selected so that the sum bⱼ+b_{w} is at least approximately equal to the axial extension bₚₘ of each magnet part 9a or 9b. Deviations of ±10% from the exact value of the sum should be allowed.

Instead of the lower counter-yoke body 6 shown in FIG. 1 which is provided with short limbs 6a to 6c, an unstructured counter-yoke body 13 having a plate or rectangular shape can be provided as shown in FIG. 2.

The embodiment of a linear drive device 15 shown in cross-section in FIG. 3 differs from that according to FIG. 1 in that in its upper part 2a, its E-shaped main yoke body 16 on the side facing the armature body 8 has special pole shoes 17a to 17c, whose axial width bⱼ corresponds to the stroke H of the armature part but has a larger axial extension b_{w i}n the winding windows outside the area of the pole surfaces Fₚ. In this case, the axial width bⱼ₁ of the individual limbs 16a to 16c is reduced compared with the pole shoes 17a to 17c placed thereon and is determined such that the magnetic flux can be carried by the iron cross-section without saturation of the iron.

According to a corresponding specific exemplary embodiment for NdFeB permanent magnet parts 9a, 9b and yoke bodies 16 and 6 made of FeSi alloy, the following values can be selected:

The following relationship is advantageously observed: bⱼ₁_W_Bⱼ.[B_{f}_{B}_{Fe}].(dₚₘ/dᵢ).

In addition:

bⱼ: width of pole shoe=stroke 20 mm

dₚₘ: thickness of permanent magnet parts 3 mm

dᵢ: width of air gap 5 mm

Bᵣ: remanence of permanent magnet parts 1.1 T

B_{Fe}: flux density in iron yoke body 1.5 T

For example: width per limb bⱼ₁ W 9 mm.

A further exemplary embodiment of a linear drive device 18 can be deduced from FIG. 4. In this case, the main yoke body and counter-yoke body are combined to form an M-shaped common yoke body 20 and common lateral limbs 20a and 20c. The axial width bⱼ₂ of its central limb 20b which leaves the gap 7 for the armature body 8 should be larger, preferably about twice as large, as the corresponding width bⱼ₃ of the lateral limbs 20a and 20c. Here also, the armature stroke H corresponds to the axial extension ₚₘ of the magnet parts 9a and 9b, where the width bⱼ₂ of the central limb 20b should preferably be greater than or equal to the magnet width bₚₘ. As can be further deduced from the figure, the width b_{w}of the winding window 4 should be greater than the armature stroke H. At the same time, on both axial sides of the yoke body the distance a between the lateral end of the armature body 8 at its maximum deflection and the respectively adjacent limb 20a to 20b should be at least half the thickness dₚₘ of the magnet parts 9a, 9b of the armature body 8; i.e. it should hold that: a W dₚₘ/2. In the figure, the maximum deflection is indicated by dashed lines.

In this embodiment of the drive device 18 provided with an M-yoke body 20, the mechanical connection 10 is guided past the lateral limb 20c on both sides. Optionally, a hole can also be provided in this limb for guiding the connection part 10.

### REFERENCE LIST

2 Drive device

1. Excitation winding

4 Winding window

5 Main yoke body

5a to 5c Limbs

6 Counter-yoke body

7 Limbs

8 Gap

9 Armature body

9a, 9b Magnet parts

10 Extension part

1. Pump piston

13 Counter-yoke body

15 Drive device

16 Main yoke body

17 Pole shoe

18 Drive device

20 Yoke body

20a to 20c Limbs

M Magnetisations

E Plane

Fₚ Pole surfaces

V Compressor

H Armature stroke

bⱼ, bⱼ₁, bⱼ₃, Limb widths

bₚₘ Magnet width

dₚₘ Magnet thickness

b₁ Air gap width

a Distance

1-13. (canceled)

14. A linear drive device comprising:
an excitation winding producing a variable magnetic field;
a magnetic-flux-guiding main yoke body accommodating the excitation winding and having multiple limbs including a central limb;
a winding-free counter-yoke body disposed opposite to the main yoke body;
an axial gap formed between the main yoke body and the counter-yoke body;
an armature body provided with at least two permanent magnetic magnet parts arranged axially one behind the other and having opposite magnetization, each of the at least two magnet parts having a magnet axial extension dimension, the armature body being set in axially oscillating motion by the magnetic field of the excitation winding in the axial gap; and
each of the multiple limbs of the main yoke body having a pole surface facing the armature body and defining a pole surface width dimension extending across the axial width of the pole surface, the pole surface width dimension of each of the multiple limbs being substantially the same, each of the multiple limbs being spaced apart from one another axially by a pole surface spacing dimension, the magnet axial extension dimension of each magnet part being approximately equal to the sum of the pole surface width dimension and the pole surface spacing dimension.

15. The drive device according to claim 14, further comprising:
winding windows holding the excitation winding between the limbs and having a window axial extension dimension extending between the adjacent limbs; and
pole shoe bodies disposed on the pole surfaces of the limbs of the main yoke body and having a pole axial extension dimension being greater than the window axial extension dimension.

16. The drive device according to claim 15, wherein the pole shoe bodies are placed on the respective limbs.

17. The drive device according to claim 14, wherein the counter-yoke body includes counter limbs having axial width dimensions at pole surfaces corresponding to the limbs of the main yoke body.

18. The drive device according to claim 14, wherein the counter-yoke body is embodied as plate-shaped.

19. The drive device according to claim 14, wherein the pole surface width dimension of at least one pole surface is substantially the same as the stroke distance of the armature body during the oscillating movement.

20. The drive device according to claim 14, wherein the magnet parts are embodied as plate-shaped.

21. The drive device according to claim 14, wherein the armature body is rigidly connected to a pump piston of a compressor.

22. A linear drive device comprising
an excitation winding producing a variable magnetic field;
a magnetic-flux-guiding main yoke body accommodating the excitation winding and having multiple limbs including a central limb and lateral limbs;
a winding-free counter-yoke body disposed opposite to the main yoke body;
an axial gap formed between the main yoke body and the counter-yoke body;
an armature body provided with at least two permanent magnetic magnet parts arranged axially one behind the other and having opposite magnetization, each of the at least two magnet parts having an axial extension dimension, the armature body being set in axially oscillating motion by the magnetic field of the excitation winding in the axial gap; and
the main yoke body and the counter-yoke body forming a common yoke body with common lateral limbs, the central limb of the main yoke body having an axial width dimension at a pole surface facing the armature body, the axial width dimension being at least as large as the axial extension dimension of each of the at least two magnet parts.

23. The drive device according to claim 22, wherein the axial width of the central limb is greater than the axial width of each lateral limb.

24. The drive device according to claim 23, wherein the axial width of the central limb is at least two times greater than the axial width of each lateral limb.

25. The drive device according to claim 22, further comprising:
winding windows holding the excitation winding between the limbs and having a window axial extension dimension extending between the adjacent limbs; and
the stroke of the armature part during the oscillating movement being smaller than the window axial extension dimension.

26. The drive device according to claim 25, wherein the window axial extension dimension is approximately equal to the maximum distance between the pole surface of the central limb and the pole surfaces of the corresponding lateral limbs.

27. The drive device according to claim 22, wherein the counter-yoke body includes counter limbs having axial width dimensions at pole surfaces corresponding to the limbs of the main yoke body.

28. The drive device according to claim 22, wherein the counter-yoke body is embodied as plate-shaped.

29. The drive device according to claim 22, wherein the pole surface width dimension of at least one pole surface is substantially the same as the stroke distance of the armature body during the oscillating movement.

30. The drive device according to claim 22, wherein the magnet parts are embodied as plate-shaped.

31. The drive device according to claim 22, wherein the armature body is rigidly connected to a pump piston of a compressor.
